(19) United States
(12) Patent Application Publication
(10) Pub. No.: US 2007/0168457 A1
(43) Pub. Date: Jul. 19, 2007

(54) Apparatus and method for addressing computer-related problems

(75) Inventors: Juan M. Huerta, Bronx, NY (US); David Lubensky, Brookfield, CT (US); Cheng Wu, Mount Kisco, NY (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 11/334,717

(22) Filed: Jan. 18, 2006

(51) Int. Cl. G06F 15/16

(52) U.S. Cl. 709/217

(57) ABSTRACT

Techniques are provided for addressing a problem pertaining to a computer of a user. In an exemplary method, the obtaining of a problem statement associated with the problem pertaining to the computer of the user is facilitated. This can be carried out via speech over a telephony connection. The establishment of a remote access connection between the computer of the user and a remote help desk application can also be facilitated. Furthermore, substantially parallel interaction with the user can be facilitated, via both the telephony connection and the remote access connection to the remote help desk application.

### FIELD OF THE INVENTION

The present invention generally relates to the data processing and related arts, and, more particularly, to addressing problems encountered by users of computers and associated software and hardware elements.

### BACKGROUND OF THE INVENTION

Significant effort has been directed at so-called “help desk” applications, where a user of a computer who is faced with a technical problem attempts to obtain a diagnosis and have a solution applied via the activity of a remote expert. Currently, problems are approached via “telephony solutions,” employing, for example, customer service representative (CSR) and interactive voice response (IVR) trees. Separate from such approaches are so-called “desktop solutions” via web pages and downloadable multi-media applications, which may be illustrative and focused in describing solutions, but which are limited to simple problems. Human customer service representatives may be helpful but are quite expensive.

United States Patent Application Publication No. US 2005/0172170 A1 of Thieret et al., dated Aug. 4, 2005, discloses methods and systems where remotely accessible machine-provided data is provided to a customer support (e.g., “help desk”) enterprise system wherein the data automatically satisfies a need for most information traditionally provided for analysis manually during a conversation. United States Patent Application Publication No. US 2003/0056140 A1 of Taylor et al., dated Mar. 20, 2003, discloses a network management system that includes a fault diagnosis system, a topology mapper, an impact analyzer and a help desk system. The help desk system includes a user interaction module and a fault diagnosis interaction module. The user interaction module is constructed and arranged to automatically communicate with a user. The fault diagnosis interaction module is constructed and arranged to communicate with a fault diagnosis system.

U.S. Pat. No. 6,353,446 to Vaughn et al., issued Mar. 5, 2002, discloses a computer program product for assisting a service person in managing an enterprise network, wherein a browser-based help desk window may be invoked by the service person at any user computer on the enterprise network that is equipped with a web browser.

Telephone-centric help desks according to the prior art may lack appropriate visual, hands-on portions. Desktop multimedia and web page solutions may be simply descriptive in nature and lack interactive features.

Given the importance, and expense, of help desks and other techniques for addressing problems encountered by computer users, it may be desirable to seek improved techniques for addressing such problems.

### SUMMARY OF THE INVENTION

Principles of the present invention provide techniques for addressing computer problems. In one aspect, an exemplary method for addressing a problem pertaining to a computer of a user can include steps of facilitating obtaining a problem statement associated with the problem pertaining to the computer of the user, facilitating establishing a remote access connection between the computer of the user and a remote help desk application, and facilitating substantially parallel interaction with the user. The problem statement can be obtained via speech over a telephony connection. The substantially parallel interaction can be via both the telephony connection and the remote access connection to the remote help desk application.

The problem statement can be obtained via speech interaction with a human operator, or preferably via speech interaction with the help desk application, employing automatic speech recognition (ASR). Optional additional steps can include facilitating user dial-in to the help desk application and facilitating authentication of the user. Further, another additional optional step can include facilitating secure access of the help desk application to the computer of the user. This can involve obtaining password and Internet protocol (IP) addresses of the user via the help desk application.

Diagnosis of the problem can be facilitated over the telephony connection. The substantially parallel interaction can include resolving the problem via the help desk application. Optionally, user viewing, on a display of the computer, of actions by the help desk application to resolve the problem can be facilitated. Such viewing can be carried out during dialog with the help desk application over the telephony connection. Such dialog can include user descriptions of viewing the actions by the help desk application, and one or more of feedback and preferences that are useful to the help desk application in the resolution of the problem.

Yet further additional optional steps can include detecting that at least a portion of the problem exceeds capabilities of the help desk application, and responsive to such detecting, automatically switching the user to a human operator.

The substantially parallel interaction can be synchronized over the telephony connection by the help desk application. The synchronization can be done via virtual presentation layer architecture, and the telephony connection and the remote access connection together can form a synchronized dual-direction bi-dimension voice and view communication channel. The help desk application can optionally initiate via graphical user interface (GUI)-specific application program interfaces (APIs) and can also employ application-specific APIs. Optionally, the telephone connection can be established via voice-over-Internet protocol (VoIP), and/or the remote access connection can be a virtual network computing (VNC) connection.

One or more embodiments of the invention can be implemented in the form of a computer program product including a computer useable medium with computer usable program code for performing one or more of the method steps indicated. Furthermore, one or more embodiments of the invention can be implemented in the form of an apparatus including a memory and at least one processor that is coupled to the memory and operative to perform one or more of the exemplary method steps, alone or in conjunction with other processors and/or memories.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates one exemplary form of a system employing techniques of the present invention;

FIG. 2 presents a flow chart depicting exemplary method steps for addressing a problem pertaining to a computer of a user according to an aspect of the present invention;

FIG. 3 is a more detailed flow chart showing one specific implementation of certain techniques according to the present invention, intended to be exemplary and not limiting; and

FIG. 4 depicts a computer system that may be useful in implementing one or more aspects and/or elements of the present invention.

### DETAILED DESCRIPTION OF PREFERRED EMBODIMENTS

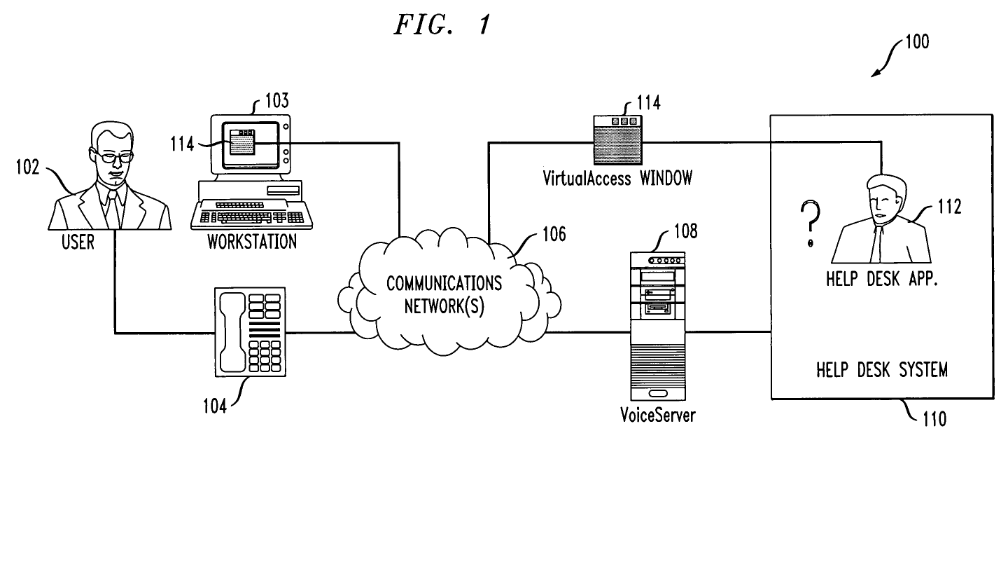

FIG. 1 shows an exemplary system 100 according to an exemplary embodiment of the present invention. This system includes a computer component, such as workstation 103, employed by a user 102. While in the example shown in FIG. 1, the problem to be addressed is associated with hardware or software of a terminal computer such as the workstation 103, it can be extended to any device or system having a network connection, such as an Internet connection. User 102 can initiate diagnostic or other procedures for addressing a problem by placing a call using a telephone 104 connected to one or more communications networks 106. In one preferred form of the invention, communications network 106 is the Internet, and workstation 103 is connected to the Internet, as is telephone 104 (for purposes of VoIP telephony). However, it is to be understood that a separate publicly switched telephone network could be employed to establish a telephony connection, and furthermore a private network or other type of network other than the Internet could be employed.

By calling an appropriate help desk number on telephone 104, user 102 can establish a connection with a voice server 108, and with a help desk system 110. Server 108 and system 110 can be separate components or can be integrated components that are interconnected. In one embodiment of the invention, a server-based application, such as J2EE, .NET, etc., that interfaces with the user 102 via a VoiceXML browser, can pick the call in the voice server 108 and authenticate the user 102. As will be discussed further below, the name and/or IP address of the user and workstation can be passed through a voice self-service channel to the help desk system application, which can conduct authentication of the user's workstation 103 via the voice channel. By way of example and not limitation, the following dialog is illustrative of such a procedure:
HELPDESK_APP: please provide your machine name or IP address
USER: 9.103.202.303
HELPDESK_APP: I will connect to it now for you (through, e.g., VNC type connection method)
HELPDESK_APP: Now I'm in the login page, what's your user ID?
USER: administrator
HELPDESK_APP: OK (the voiced-in user name is automatically passed to the VNC login page by HELPDESK_APP)
HELPDESK_APP: please say your password USER: xxxxxxx (the voiced-in/keyed-in password is automatically passed to the VNC login page by HELPDESK_APP)
HELPDESK_APP: good; now we are on your machine, let me check your configuration first.

Through one or more voice interactions, a problem category can be identified and/or other types of diagnosis can be performed in order to determine an appropriate action to be taken to address the problem. Action classification or a simple directed dialog call flow can be employed. If it is believed that the problem can be addressed by the appropriate help desk application 112 on help desk system 110, processing can continue; if this is not believed feasible, the application 112 can route the call to a human operator, or refer the user 102 to any other source of help. Note that help desk application 112 is represented by a figure of a human being, and it will be appreciated that in some applications of techniques of the invention, instead of interaction with a voice server via automatic speech recognition (ASR), interaction with a human operator, over the telephone 104, can be employed in connection with the remote access connection to be discussed below.

Where a determination has been made that the help desk application 112 is likely to be able to address the problem with workstation 103 or another computer element, workstation 103 can be identified, for example, as discussed in the above dialog, or through speech, interactive voice response, a database, or an instant messaging robot. Such instant messaging robots, suitable for the purposes set forth herein, can be readily developed by the skilled artisan using available technology plus the teachings of the present invention. For example, a suitable robot can be built using the API of an instant messaging application, such as the LOTUS SAMETIME® instant messaging program available from International Business Machines Corporation. Thus, the problem host, or user workstation machine can be identified.

The help desk application 112 can assume remote GUI control of the problem host, such as workstation 103, via a suitable remote access connection. One suitable form of remote access connection is a virtual network connection provided via the virtual access windows 114 on system 110 and workstation 103, established by communications over network 106. For security purposes, such access can be controlled via an administrator password stored in machine inventory profiles.

System 110, with application 112, in conjunction with server 108, virtual access window 114, and telephone 104, operating over network or networks 106, can then begin to address the problem, such as, for example, confirming or completing diagnosis and initiating resolution. Remote GUI operation can be employed, by remotely accessing the problem application and the problem host such as workstation 103. System 110 can synchronously interact with user 102 in order to capture further information to aid in the further diagnosis, problem resolution, configuration, reconfiguration, enhancement, optimization or other operation on the application or system that is causing trouble.

Feedback from the diagnosis program launched by the help desk application 112 can be reviewed by the user 102 over the viewing channel, in a full bi-directional procedure. User 102 can stop and/or redirect the diagnosis program, and the user's input through the voice channel can be considered by the diagnosis program through the self-service channel interfacing with the help desk application 112. Thus, the telephone connection can serve as a command and control channel for the VNC or other remote access connection part of the combined application, while the viewing channel can be employed to monitor and/or collect feedback from the diagnosis program. Upon completion, the VNC or other remote access connection can be closed, and the telephony connection can be terminated.

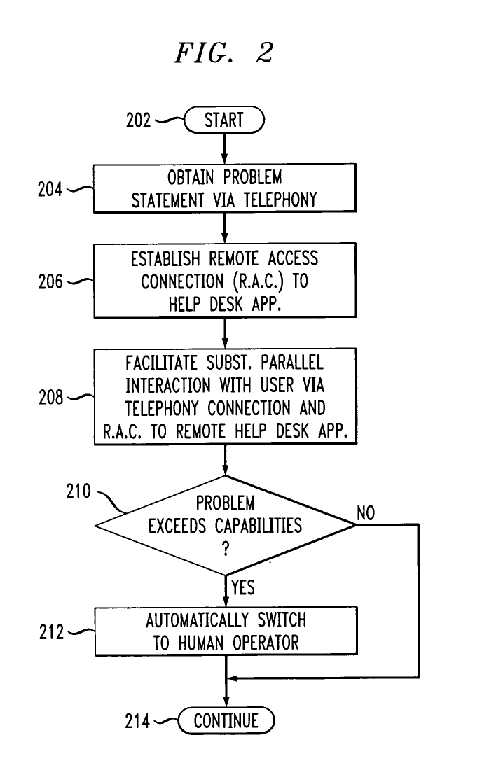

FIG. 2 shows a flow chart 200 of exemplary method steps in a method for addressing a problem pertaining to a computer of a user, according to one aspect of the present invention. After beginning at block 202, a step of facilitating obtaining, via speech over a telephony connection, a problem statement associated with the problem pertaining to the computer of the user can be performed as shown at block 204. A step of facilitating establishing a remote access connection between the computer of the user and a remote help desk application can be performed as shown at block 206. As shown at block 208, substantially parallel interaction with the user can be facilitated via both the telephony connection and the remote access connection to the remote help desk application.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

The problem statement obtained in step 204 can be obtained via speech interaction with a human operator. Alternatively, in one or more embodiments of the invention, the problem statement can be obtained via speech interaction with the help desk application. The help desk application can employ ASR. Note that the computer of the user having the problem should be broadly construed to include a workstation, server, personal computer, peripheral devices, software, network components, and the like amenable to techniques of the present invention.

As shown at decision block 210, a step of detecting that at least a portion of the problem exceeds capabilities of the help desk application can optionally be conducted. Responsive to a determination that such is indeed the case, a step 212 of automatically switching the user to a human operator can be performed. Processing continues at block 214.

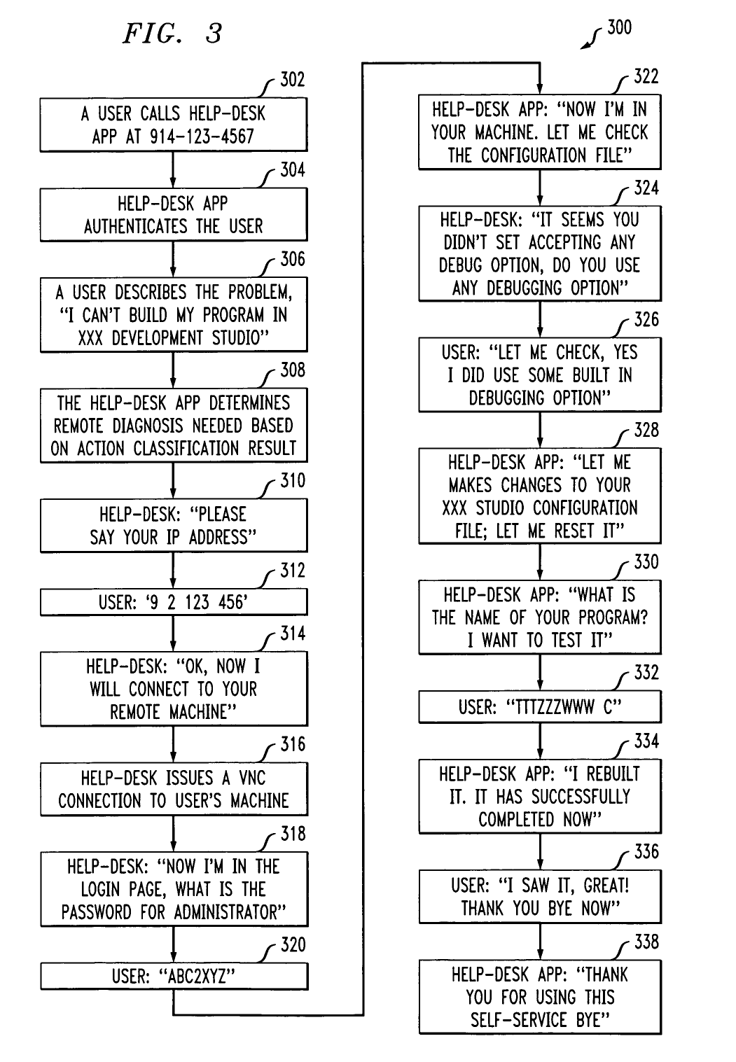

It will be appreciated that the methods depicted and described with respect to FIGS. 2 and 3 herein are exemplary in nature, and more or fewer steps than those indicated may be performed; furthermore, the steps may be performed in different orders than those depicted.

Attention should now be given to FIG. 3, which depicts a flow chart 300 showing exemplary method steps in a more specific detailed implementation of certain techniques of the present invention. At step 302, a user calls a particular help desk application at the indicated number, while at step 304 the help desk application authenticates the user. It will be appreciated that, in general, these steps correspond to facilitating user dial-in to the help desk application, and facilitating authentication of the user. As shown in step 306, a problem statement is obtained. In the example depicted, the user describes the problem as inability to build a program in a certain development studio. At step 308, the help desk application determines that remote diagnosis is needed, based on an action classification result.

At steps 310 and 312, the help desk prompts the user to say his or her IP address and the user responds. At step 314, the help desk application indicates that it will connect to the user's remote machine, and at step 316, the help desk application issues a VNC or other connection to the user's machine. In step 318, the help desk application has accessed the log-in page, and asks the user for the password for the administrator. The user responds at step 320. Using this password, the remote help desk application is able to access the machine, as indicated at block 322, where the application further indicates that it will check the configuration file. It will be appreciated that steps 310-322 are specific examples of more general steps of facilitating secure access of the help desk application to the computer of the user, including the obtaining of a password and IP address of the user via the help desk application.

In step 324, the help desk application determines that the user did not set the acceptance of any debug option, and queries whether the user in fact uses any debugging option. In step 326, the user replies that he or she will check, and then affirms that he or she did in fact use some built in debugging option. It will be appreciated that steps 324 and 326 are specific illustrations of a general step of facilitating viewing by the user, on a display of the computer, of actions by the help desk application to resolve the problem. The viewing can be carried out during dialog with the help desk application over the telephony connection.

In step 328, the help desk application advises the user that it will be making changes to the configuration file of the malfunctioning application, in particular, indicating that it will reset it. In step 330, the help desk application requests the name of the source program that the user has been working on so as to test it. In step 332, the user replies with the name of the C-language source file. In step 334, the help desk application indicates that it has rebuilt the program and that it has now successfully executed. The user has viewed the process and replies, in step 336, that he or she has seen the successful execution and responds with a thank you and a good bye. It will be appreciated that steps 326-336 are one specific example of a dialog comprising user descriptions of viewing of the actions by the help desk application, including one or more of feedback and preferences that are useful to the help desk application in resolution of the problem. In step 338, the help desk application returns the thank you and utters an appropriate good bye.

With the foregoing description of FIGS. 2 and 3 in mind, it will appreciated that methods according to the present invention can include facilitation of diagnosis of the problem over the telephony connection. Furthermore, the substantially parallel interaction can include resolution of the problem via the help desk application. The substantially parallel interaction can be synchronized over the telephony connection by the help desk application. In some embodiments of the invention, the help desk application can initiate via GUI-specific APIs and can also employ application-specific APIs. While any type of telephony connection can be employed, it is believed preferable that the connection be established via VoIP. As noted, in one preferred form of the invention, the remote access connection is a VNC connection. However, any suitable remote access connection can be employed.

The substantially parallel interaction can, as mentioned, be synchronized over the telephony connection by the help desk application. One preferred manner to accomplish this is via virtual presentation layer architecture. The telephony connection and the remote access connection together form a synchronized dual-direction and bi-dimension voice and view communication channel.

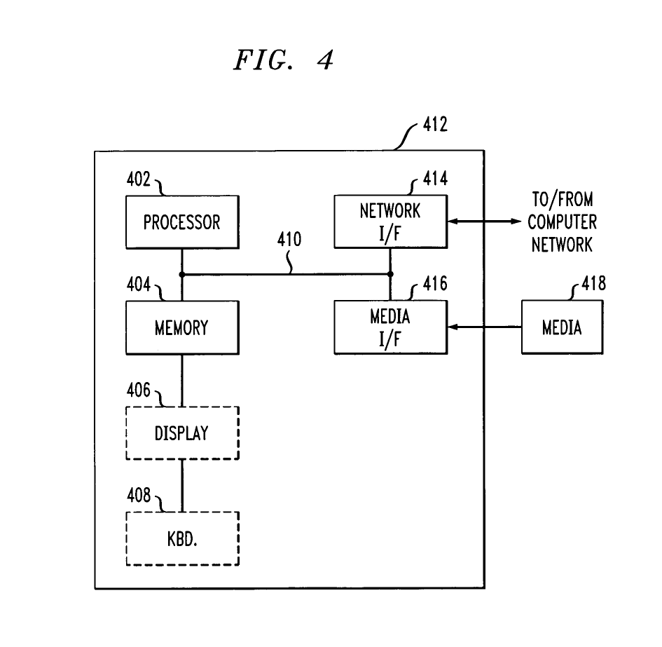

In view of the foregoing discussion, it will be appreciated that the present invention can provide an apparatus for addressing a problem pertaining to a computer of a user. The apparatus can include a memory and at least one processor coupled to the memory and operative to perform one or more of the method steps indicated herein, or to facilitate their performance. One of more of the method steps described herein can be implemented in the form of a computer program product. Further details regarding computer systems and computer program products are discussed with regard to FIG. 4 below. It should be noted that in one preferred form of the invention, as shown in FIG. 1, a help desk application runs on a machine implementing the help desk system, as indicated with regard to elements 110 and 112, and such components interface with the voice server 108. Thus, in one aspect, the present invention provides a help desk system for addressing a problem pertaining to a computer of a user, in conjunction with a voice server that is configured to facilitate obtaining, via speech over a telephony connection, a problem statement associated with the problem pertaining to the computer of the user. The help desk system can include a memory and at least one processor coupled to the memory. The processor can be operative to facilitate establishing a remote access connection between the computer of the user and the help desk system, and to facilitate substantially parallel interaction with the user via both the telephony connection and the remote access connection to the help desk system.

Furthermore, the present invention can include, in another aspect, a voice server for addressing a problem pertaining to a computer of a user, in conjunction with a help desk system that is configured to facilitate establishing a remote access connection between the computer of the user and the help desk system. The voice server can include a memory and at least one processor that is coupled to the memory and operative to facilitate obtaining, via speech over a telephony connection, a problem statement associated with the problem pertaining to the computer of the user, and also to facilitate substantially parallel interaction with the user via both the telephony connection and the remote access connection to the remote help desk application. Note that the telephony “connection” should be broadly understood to include connection-oriented services such as a traditional telephone network as well as connectionless services such as VoIP using the Internet. Session Initiation Protocol (SIP) is another possibility.

It will be appreciated that the foregoing description of the voice server and help desk system is merely illustrative of one particular form of the invention currently believed to be preferable, but that different method steps may be performed by the voice server and the help desk system, or by other processing equipment, or that the functionality can be combined into a single machine executing an appropriate software module or modules.

In view of the foregoing discussion, it will be appreciated that one or more embodiments of the invention provide a framework for a hybrid customer service for troubleshooting hardware and/or software products. A visual part can be added to traditional customer service and self service by phone, which are typically telephone-centric, and can synchronize the actions and conversations between a virtual or human agent and a user on the aforementioned virtual presentation layer. A self service agent, such as the help desk application 112, employs rule based or data driven expert systems in conjunction with an ASR program. A human customer service expert can also be employed. Either the self service or human agent logs into the system of the user, gaining authorized access to the system that is in trouble through an authenticated network connection. This can occur while the user is talking to the conversational portion of the agent over a telephony connection. A virtual agent system, or human expert, in the customer service center can make inquiry over the telephony connection with any questions necessary regarding the ongoing diagnosis work, while the user can view the visual part. The log in authentication of the virtual agent can be fully controlled by the user for security reasons, and the diagnosis work performed by the virtual or human agent can be under visual monitoring by the user.

One or more of three concepts may be pertinent to one or more embodiments of the invention. These include remote session and host system, synchronized dual-direction, and bi-dimension communications channel. The virtual agent system or human CSR with appropriate expertise can access the host system, in front of a user, through a remote session with GUI-specific APIs. The user can visually monitor the remote session, such as the aforementioned VNC access, and can grant access permissions as necessary. Furthermore the user has the opportunity to learn diagnosis steps and procedure which may be of future use. The two sides, which may be physically unable to see each other, can be synchronized through the aforementioned telephony connection via the voice activated self-service application. The three concepts just discussed, completed and taken together, form the aforementioned synchronized dual-direction and bi-dimension voice and view communication channel.

Based on the synchronized dual-direction and bi-dimension voice and view communication channel, one or more embodiments of the present invention can provide a self-service mode for call centers wherein the user dials, the dual communication channel is established, user authentication occurs via the telephone channel, and a user and virtual or human agent can interact via the voice server, with the application, through the telephone connection. The user machine's IP address is accessed over the appropriate network connection, and the help desk application initiates to execute the solution via GUI-specific APIs.

While, as noted, any type of telephony connection can be employed, recent progress in VoIP technology can result in the merging of the data and voice networks, providing potential new ground. Even in the case of a remote host system, a user can still have a view channel on the diagnosis that is taking place on the host system via the specific IP phone with screen.

By way of reiteration, various exemplary methods have been described with regard to FIGS. 2 and 3. One further specific approach embodying the synchronized dual-direction and bi-dimension voice and view communication channel will be summarized with regard to the following steps. A user dials into the voice activated speech help-desk application. The user is authenticated via a telephone channel by the self-service application. This step is preferably conducted first, before further interaction takes place.

The user interacts via voice with the conversational application through the telephony connection. A diagnosis of the problem is made via speech interaction. The IP address of the user's machine, experiencing the problem, is provided and identified, and a new connection to the problem machine is opened via a VNC or other type of remote channel, using the password supplied by the user over the voice channel. The VNC or other connection can be initiated, e.g., by an instant messaging robot of the kind discussed above. Once the diagnosis is made, the self service application interacts with the user to resolve the problem.

The help desk application can initiate to execute the solution via GUI-specific (e.g., keyboard, mouse, and the like) APIs. In addition, the help desk application can make use of application specific APIs. While these events are occurring, the application can keep a dialog with the user on the telephony connection, and the user can describe what is happening in the VNC or other remote connection from his or her view channel, and provide feedback information and user preferences that help the help desk self service application in finding an appropriate solution, which can be customized. As noted, if the self service application detects that the problem is too complicated to proceed, it can automatically switch to a human agent or a human agent's assistant.

Thus, one or more embodiments of the invention can provide a framework for self service in which both the interactive (diagnosis and troubleshooting) component and the solution (i.e., actually stepping through the solution of the problem) features are provided via a dual communications channel. The user dialing, user authentication via a telephone channel, and user voice interaction with the application via a voice server through the telephony connection can be carried out as described herein. The user's machine's IP address can be provided, and a help desk application can initiate to execute the solution via GUI-specific APIs. Thus, a scenario and a procedure for remote and automated problem diagnosis troubleshooting and solution can be provided, which can include one or more of the steps described herein.

A variety of techniques, utilizing dedicated hardware, general purpose processors, firmware, software, or a combination of the foregoing may be employed to implement the present invention. At present, it is believed that the preferred implementation will make substantial use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (e.g., hard drive), a removable memory device (e.g., diskette), a flash memory and the like. In addition, the phrase “input/output interface” as used herein, is intended to include, for example, one or more mechanisms for inputting data to the processing unit (e.g., mouse), and one or more mechanisms for providing results associated with the processing unit (e.g., printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (e.g., ROM, fixed or removable memory) and, when ready to be utilized, loaded in part or in whole (e.g., into RAM) and executed by a CPU. Such software could include, but is not limited to, firmware, resident software, microcode, and the like.

Furthermore, the invention can take the form of a computer program product accessible from a computer-usable or computer-readable medium (e.g., media 418) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (e.g. memory 404), magnetic tape, a removable computer diskette (e.g. media 418), a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor 402 coupled directly or indirectly to memory elements 404 through a system bus 410. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, e.g., application specific integrated circuit(s) (ASICS), functional circuitry, one or more appropriately programmed general purpose digital computers with associated memory, and the like. Given the teachings of the invention provided herein, one of ordinary skill in the related art will be able to contemplate other implementations of the components of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for addressing a problem pertaining to a computer of a user, comprising the steps of:
facilitating obtaining, via speech over a telephony connection, a problem statement associated with the problem pertaining to the computer of the user;
facilitating establishing a remote access connection between the computer of the user and a remote help desk application; and
facilitating substantially parallel interaction with the user via both:
said telephony connection; and
said remote access connection to said remote help desk application.

2. The method of claim1, wherein said problem statement is obtained via speech interaction with a human operator.

3. The method of claim 1, wherein said problem statement is obtained via speech interaction with said help desk application, said help desk application employing automatic speech recognition (ASR).

4. The method of claim 3, further comprising the additional steps of:
facilitating user dial-in to said help desk application; and
facilitating authentication of the user.

5. The method of claim 4, further comprising the additional step of facilitating secure access of said help desk application to the computer of the user.

6. The method of claim 5, wherein said step of facilitating secure access comprises obtaining a password and Internet protocol (IP) address of the user via said help desk application.

7. The method of claim 3, further comprising facilitating diagnosis of the problem over said telephony connection.

8. The method of claim 7, wherein said substantially parallel interaction comprises resolving the problem via said help desk application.

9. The method of claim 8, further comprising the additional steps of facilitating viewing by the user, on a display of the computer, of actions by said help desk application to resolve the problem, said viewing being carried out during dialog with said help desk application over said telephony connection.

10. The method of claim 9, wherein said dialog comprises user descriptions of viewing said actions by said help desk application and at least one of feedback and preferences useful to said help desk application in said resolving of the problem.

11. The method of claim 10, further comprising the additional steps of:
detecting that at least a portion of the problem exceeds capabilities of said help desk application; and
responsive to said detecting, automatically switching the user to a human operator.

12. The method of claim 8, wherein said substantially parallel interaction is synchronized over said telephony connection by said help desk application.

13. The method of claim 12, wherein said help desk application initiates via graphical user interface (GUI)-specific application program interfaces (APIs) and also employs application-specific APIs.

14. The method of claim 1, wherein said telephony connection is established via voice-over-Internet protocol (VoIP).

15. The method of claim 1, wherein said remote access connection comprises a virtual network computing (VNC) connection.

16. A computer program product comprising a computer usable medium having computer usable program code for addressing a problem pertaining to a computer of a user, said computer program product including:
computer usable program code for facilitating obtaining, via speech over a telephony connection, a problem statement associated with the problem pertaining to the computer of the user;
computer usable program code for facilitating establishing a remote access connection between the computer of the user and a remote help desk application; and
computer usable program code for facilitating substantially parallel interaction with the user via both:
said telephony connection; and
said remote access connection to said remote help desk application.

17. The computer program product of claim 16, wherein said problem statement is obtained via speech interaction with said help desk application, said help desk application employing automatic speech recognition (ASR).

18. The computer program product of claim 17, wherein said product further includes computer usable program code for:
facilitating user dial-in to said help desk application; and
facilitating authentication of the user.

19. The computer program product of claim 18, wherein said product further includes computer usable program code for facilitating secure access of said help desk application to the computer of the user.

20. The computer program product of claim 17, wherein said product further includes computer usable program code for facilitating diagnosis of the problem over said telephony connection.

21. The computer program product of claim 20, wherein said substantially parallel interaction comprises resolving the problem via said help desk application.

22. The computer program product of claim 21, wherein said product further includes computer usable program code for facilitating viewing by the user, on a display of the computer, of actions by said help desk application to resolve the problem, said viewing being carried out during dialog with said help desk application over said telephony connection.

23. The computer program product of claim 22, wherein said dialog comprises user descriptions of viewing said actions by said help desk application and at least one of feedback and preferences useful to said help desk application in said resolving of the problem.

24. The computer program product of claim 21, wherein said substantially parallel interaction is synchronized over said telephony connection by said help desk application.

25. An apparatus for addressing a problem pertaining to a computer of a user, comprising:
a memory; and
at least one processor coupled to said memory and operative to:
facilitate obtaining, via speech over a telephony connection, a problem statement associated with the problem pertaining to the computer of the user;
facilitate establishing a remote access connection between the computer of the user and a remote help desk application; and
facilitate substantially parallel interaction with the user via both:
said telephony connection; and
said remote access connection to said remote help desk application.

26. The apparatus of claim 25, wherein said problem statement is obtained via speech interaction with said help desk application, said help desk application employing automatic speech recognition (ASR).

27. The apparatus of claim 26, wherein said at least one processor is further operative to:
facilitate user dial-in to said help desk application; and
facilitate authentication of the user.

28. The apparatus of claim 27, wherein said at least one processor is further operative to facilitate secure access of said help desk application to the computer of the user.

29. The apparatus of claim 26, wherein said at least one processor is further operative to facilitate diagnosis of the problem over said telephony connection.

30. The apparatus of claim 29, wherein said substantially parallel interaction comprises resolving the problem via said help desk application.

31. The apparatus of claim 30, wherein said at least one processor is further operative to facilitate viewing by the user, on a display of the computer, of actions by said help desk application to resolve the problem, said viewing being carried out during dialog with said help desk application over said telephony connection.

32. The apparatus of claim 31, wherein said dialog comprises user descriptions of viewing said actions by said help desk application and at least one of feedback and preferences useful to said help desk application in said resolving of the problem.

33. The apparatus of claim 30, wherein said substantially parallel interaction is synchronized over said telephony connection by said help desk application via a virtual presentation layer architecture, said telephony connection and said remote access connection together forming a synchronized dual-direction bi-dimension voice and view communication channel.

34. A help desk system for addressing a problem pertaining to a computer of a user, in conjunction with a voice server that is configured to facilitate obtaining, via speech over a telephony connection, a problem statement associated with the problem pertaining to the computer of the user, said help desk system comprising:
a memory; and
at least one processor coupled to said memory and operative to:
facilitate establishing a remote access connection between the computer of the user and said help desk system; and
facilitate substantially parallel interaction with the user via both:
the telephony connection; and
said remote access connection to said help desk system.

35. An voice server for addressing a problem pertaining to a computer of a user, in conjunction with a help desk system that is configured to facilitate establishing a remote access connection between the computer of the user the said help desk system, said voice server comprising:
a memory; and
at least one processor coupled to said memory and operative to:
facilitate obtaining, via speech over a telephony connection, a problem statement associated with the problem pertaining to the computer of the user; and
facilitate substantially parallel interaction with the user via both:
said telephony connection; and
the remote access connection to the remote help desk application.
